(19) United States
(12) Patent Application Publication
(10) Pub. No.: US 2005/0021465 A1
(43) Pub. Date: Jan. 27, 2005

(54) Strategic business tool and method for financial institutions

(76) Inventor: John Richard Segerstrom, Lake Oswego, OR (US)

Correspondence Address: KOLISCH HARTWELL, P.C., 520 S.W. YAMHILL STREET, SUITE 200, PORTLAND, OR, 97204, US

(21) Appl. No.: 10/763,571

(22) Filed: Jan. 23, 2004

Related U.S. Application Data
(63) Continuation-in-part of application No. 10/742,698, filed on Dec. 19, 2003.
(60) Provisional application No. 60/442,957, filed on Jan. 27, 2003.

(51) Int. Cl. G06F 17/60

(52) U.S. Cl. 705/42

(57) ABSTRACT

A strategic business method for financial institutions includes the steps of establishing a strategic metric, setting measurable goals using the established strategic metric, communicating the goals effectively, and measuring and reporting progress in reaching the goals. A strategic business tool for financial institutions includes structure for establishing a strategic metric, structure for setting measurable goals using the established strategic metric, structure for communicating the goals effectively, and structure for measuring and reporting progress in reaching the goals.

### CROSS-REFERENCE TO RELATED APPLICATIONS

This application claims priority to U.S. Provisional Patent Application Ser. No. 60/442,957, filed Jan. 27, 2003 and entitled “Strategic Business Tool and Method for Financial Institutions”. This application is also a continuation-in-part of U.S. patent application Ser. No. 10/742,698, filed Dec. 19, 2003, and entitled “Strategic Business Tool and Method for Financial Institutions”.

### BACKGROUND AND SUMMARY OF INVENTION

The practice of Strategic Management, part of which is “strategic planning”, is today an open circuit: because there is no strategic metric, there is no way to set measurable goals, communicate them meaningfully, and then measure and report progress in reaching them. There can be no control or refinement of individual activities (the building blocks of a strategy). Resource allocation is based on experience, interpretation and luck. In every case, the Bank has two strategies: (1) the TARGET STRATEGY of the governing body and management and (2) the ACTUAL STRATEGY resulting from the sum of individual activities actually being undertaken in the organization.

The invention described below in the specification, figures and attachment may be characterized as a strategic business method for financial institutions. The method includes the steps of establishing a strategic metric, setting measurable goals using the established strategic metric, communicating the goals effectively, and measuring and reporting progress in reaching the goals. The invention may also be thought of as a strategic business tool for financial institutions that includes structure for establishing a strategic metric, structure for setting measurable goals using the established strategic metric, structure for communicating the goals effectively, and structure for measuring and reporting progress in reaching the goals. The structure is preferably in the form of software that is described further below.

Michael Porter (Harvard Business School) has proposed a strategic “common denominator” as a basic dimension of strategy: DIFFERENTIATION (“Value”)<STRATEGY<EFFICIENCY (“Price”).

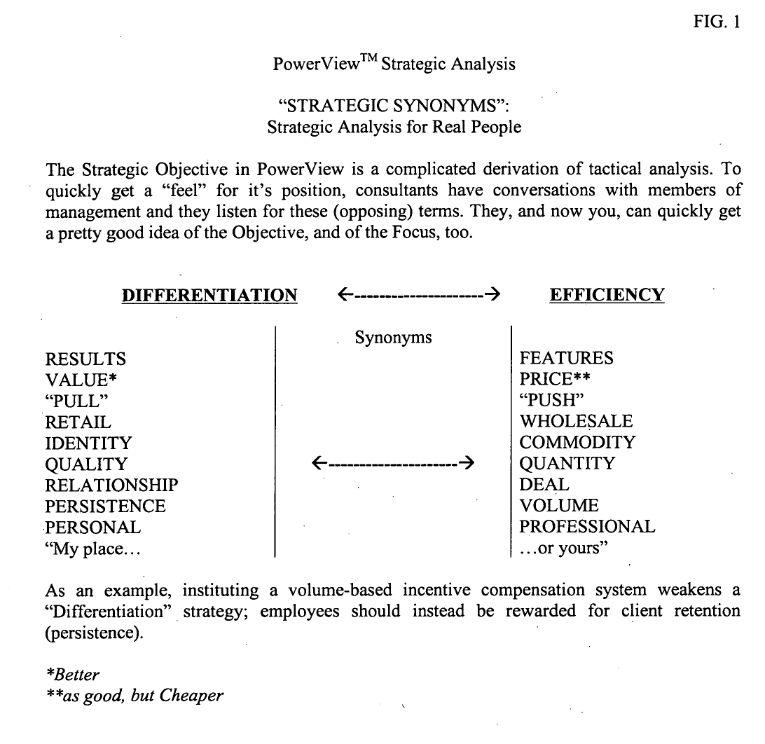

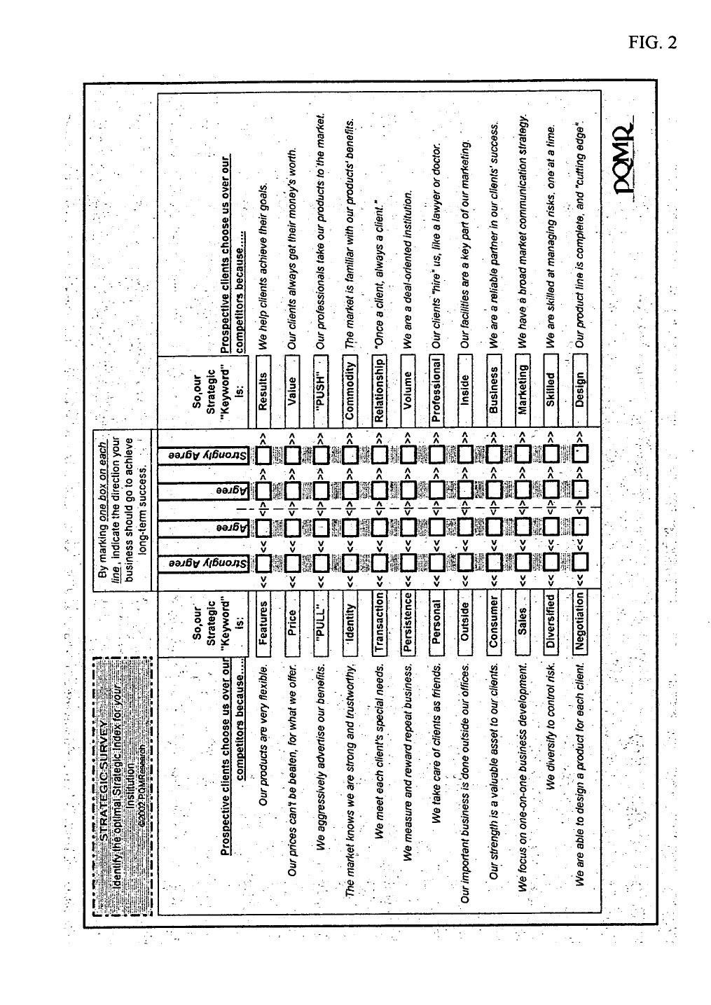

Job #1: Translate Board/Management expertise and factual knowledge onto Porter's dimension. (a) PQMR proposes “synonyms” for the Porter dimension's end points. (FIG. 1); (b) The PQMR Strategic Survey (FIG. 2) uses these opposing concepts to facilitate conversation by the responsible governing body about strategy, on Porter's dimension; (c) The completed Strategic Survey is scored to estimate the strategic position implied by the goals of the planning body: a survey score of “0” implies a pure “Value” strategy, and “100” implies “Price”; (d) The survey also scores “Internal Focus”, defined here as the internal consistency of responses to the Survey's strategic dimensions, by individual participants and by the group in total. The goal of the ensuing discussion is to maximize “Internal Focus” at a particular combined “Target Strategy” score. This “Target Strategy” is the first of the Bank's two strategies.

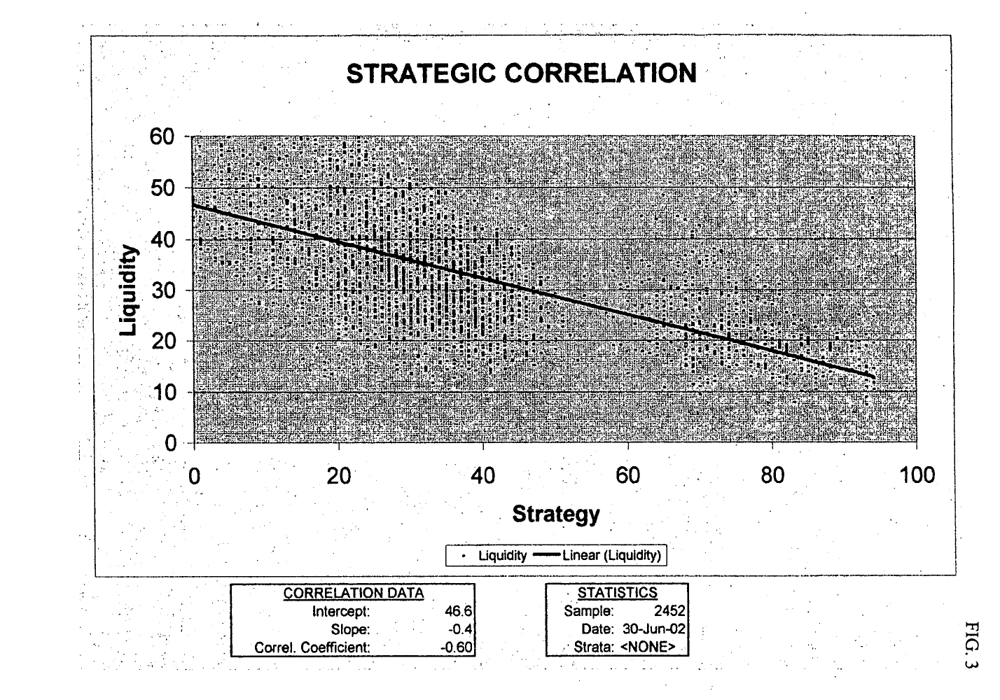

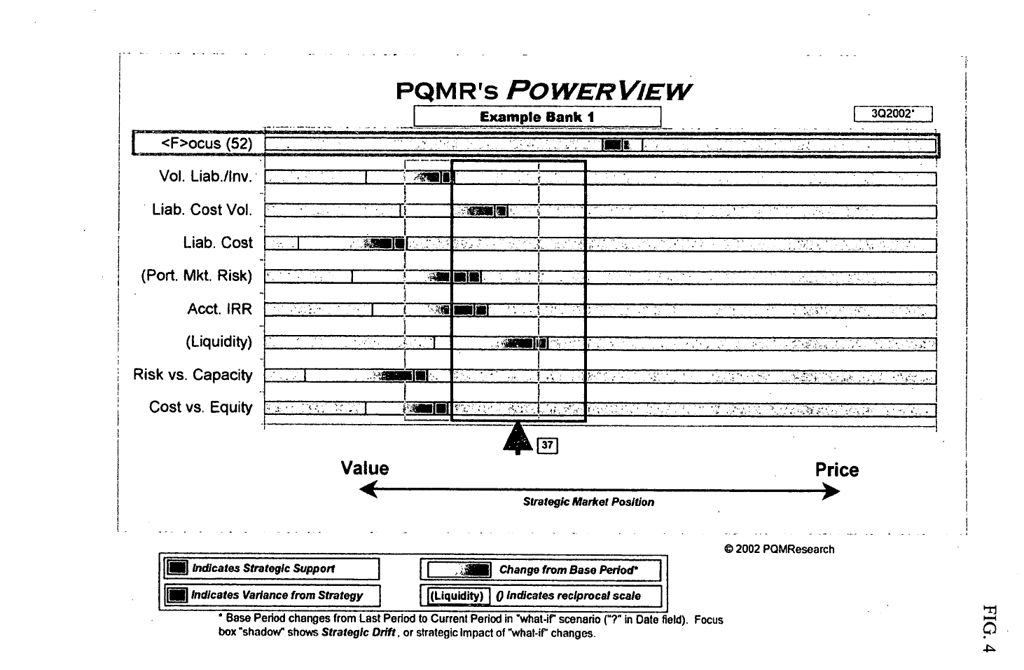

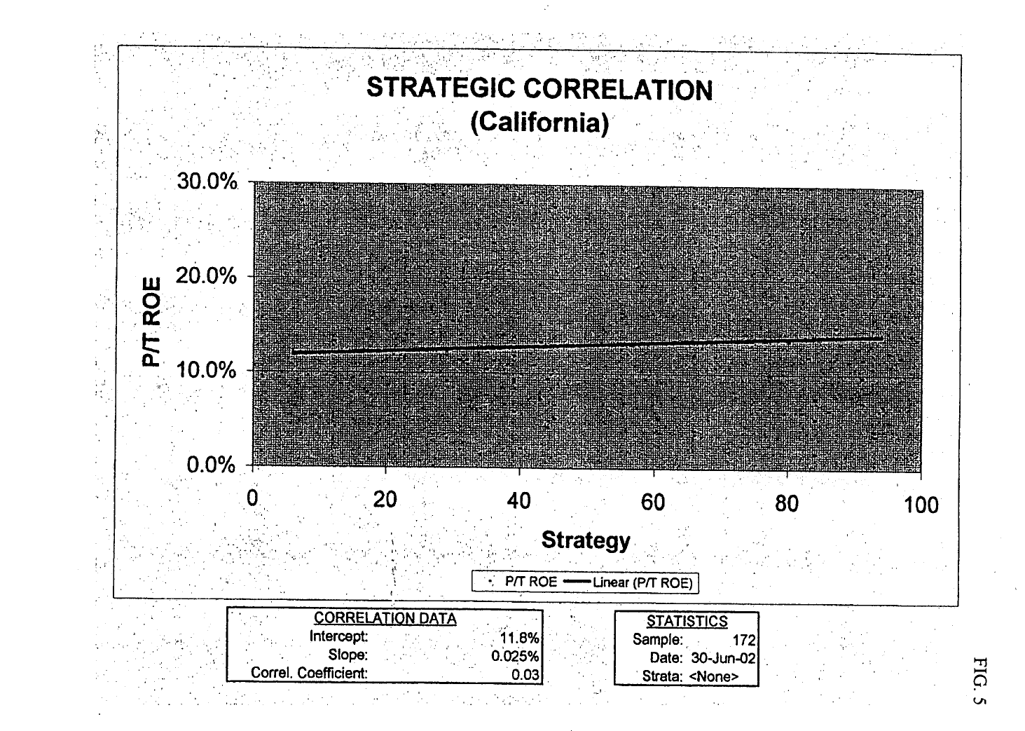

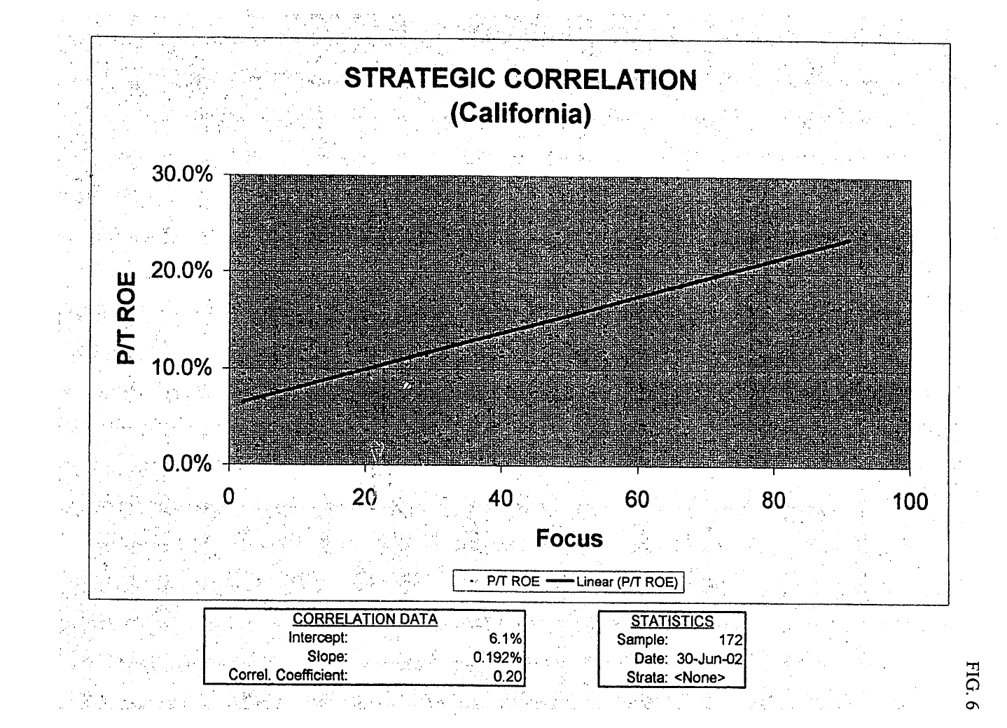

Job #2: Measure the second of the Bank's two strategies: the “Actual Strategy”. (a) Each of the activities making up the “Actual Strategy” leaves telltale footprints (for example, lower Liquidity, defined as liquid assets divided by total assets, arises from pursuit of a “Price” strategy. FIG. 3 confirms this using actual data from over 5,000 U.S. banks); (b) PowerView measures such footprints, translates them into tactical measures and infers the “Actual Strategy” that they represent, when viewed together (FIG. 4). There are no good or bad strategies (FIG. 5 shows no significant correlation between “Actual Strategy” and profitability among California banks, for example), but adopting a clear strategy is a critical key to success: a clear goal for the various tactics is essential if they are to be aligned to achieve that goal; (c) PowerView also evaluates how the tactical activity measures are aligned behind the “Actual Strategy”, and assigns a “Calculated Focus” score: how well, on average, do individual tactics support the overall strategy. This is compared to the Strategic Survey's “Internal Focus”: aligned tactics (a high “Calculated Focus”) is the critical determinant of financial success (FIG. 6).

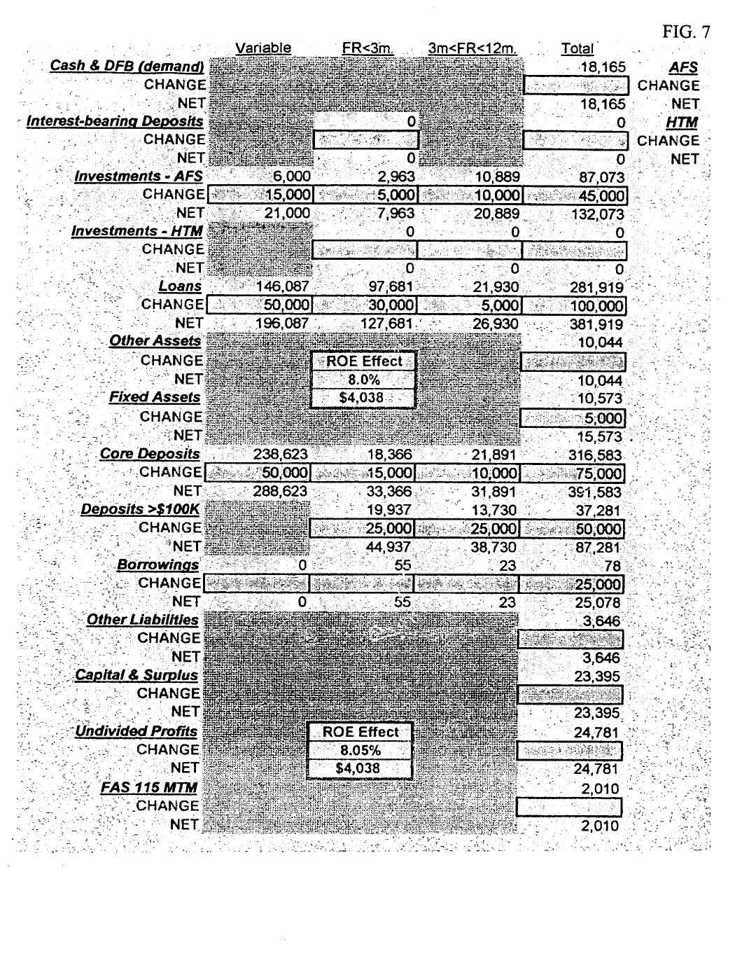

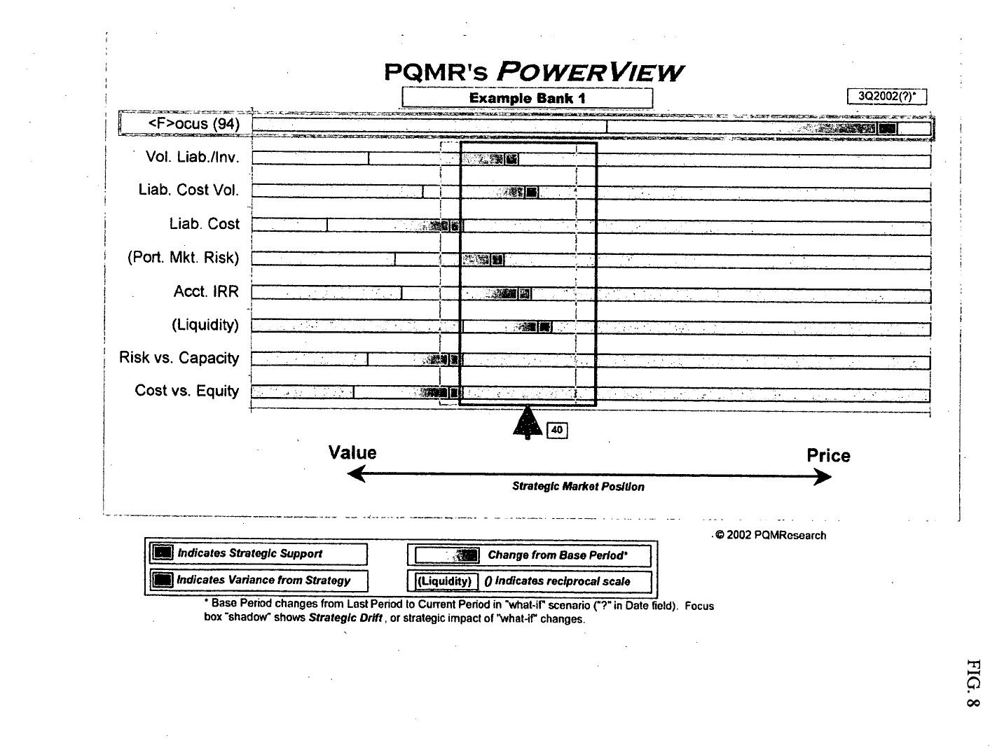

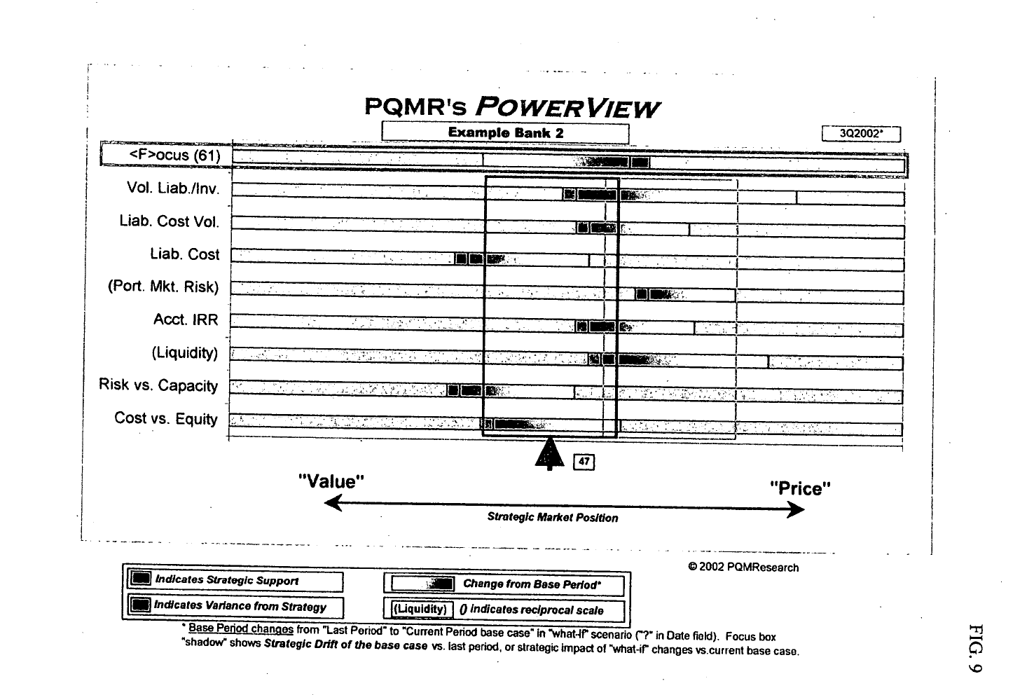

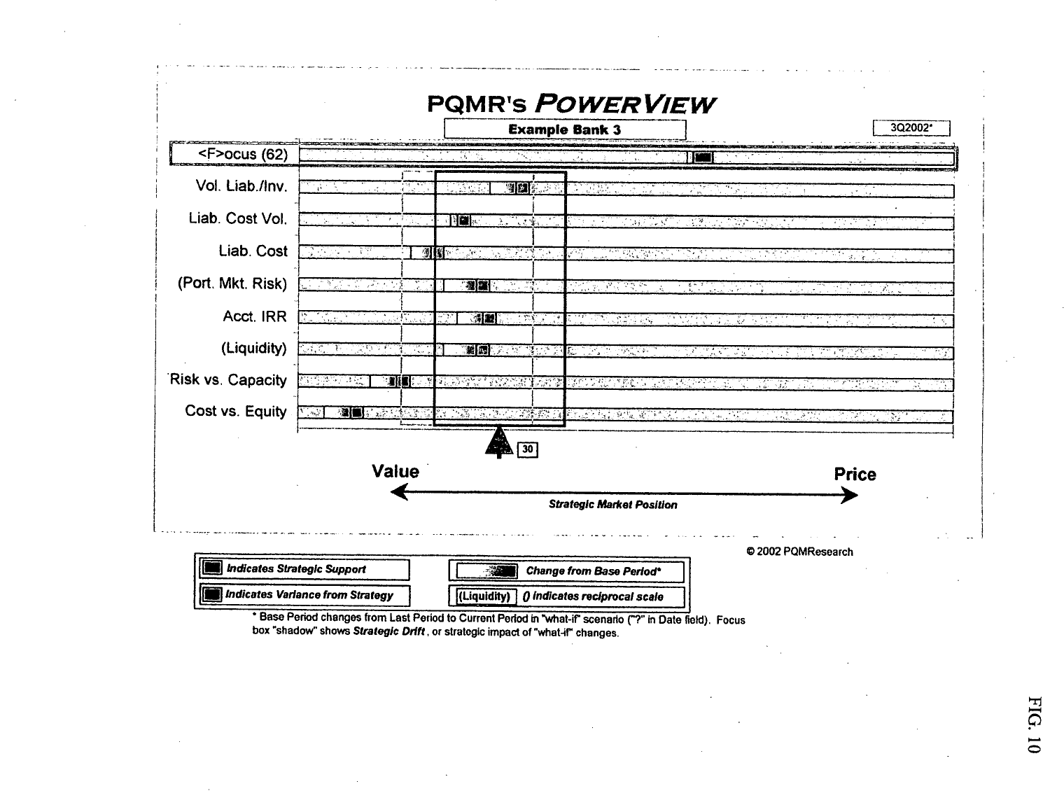

Job #3: The “Strategic Plan”: The strategic plan sets forth steps to adjust individual Bank activities to: (a) Conform the “Actual Strategy” to the “Target Strategy”; (b) Maximize the “Calculated Focus” score; (c) PowerView's “what-if” capability allows exploration of strategic alternatives, and selection of the best path to (a) and (b), from an ease of implementation and market opportunity standpoint (FIG. 7, resulting in FIG. 8); (d) The PowerView structure allows communication of tactical goals, based on the “Target Strategy”, throughout the organization, in common terms brought to the individual department, and even the individual employee level.

PowerView provides a tool to measure progress toward achieving the “Strategic Plan's” objectives. Every six months, management and the board receive an objective measure of “Actual Strategy” and “Calculated Focus” (FIG. 4), and can clearly see successes to celebrate, and failures requiring management attention. Annually, the “Strategic Plan” itself can be re-examined by all stakeholders, again in common terms. Thus, PowerView for the first time allows the “Strategic Management” cycle to be complete. A business strategy is not a military strategy: It should never be patterned to seek outright victory over an adversary. A “victory” strategy in business (a) is too risky, (b) misses the point in the context of a perpetual marketplace, and (c) leads toward possibly illegal (i.e. monopolistic) behavior.

A business' strategy seeks the consistent strength to withstand any threats to the organization's perpetual existence. The strategic goal of a business is first to become, and then to remain a “going concern” in the classical definition.

The voyage truly is the destination, and business strategies must recognize this reality, from design to implementation to execution. As business, so banking: a paradigm of bank strategy different from the military model is essential for strategy to deliver on its promise.

The Strategic Dimension

In the simplest terms, strategic success arises from serving customers at a consistent profit. In a fluid, competitive marketplace, the first step on the path to this success is for potential profitable customers to choose your bank over its competitors, and the second is for current profitable customers to remain. Logically, then, your first and most important strategic task is to give both groups a reason to choose you.

Customers become and remain your customers for two reasons. They choose you on the basis of lowest PRICE; or because you offer something of VALUE to them that the competition can't match. These competitive alternatives—VALUE, and PRICE—define a Strategic Dimension for banking:

VALUE <<<<<<<<<<<<<|>>>>>>>>>>>>>PRICE

Each strategic alternative places a unique, critical demand on the organization. A PRICE strategy demands Efficiency: the bank must be able to profit consistently at the lowest prices in the marketplace. On the other hand, a VALUE strategy requires Differentiation: the bank must establish a unique position for its products, so that it can emphasize its products' features and de-emphasize price in meeting competition. Every bank's strategy is unique, driven by its values, market opportunity and competition; but virtually every strategic design I have studied¹—over 6,000 institutions—emphasizes one end of this Strategic Dimension or the other (a VALUE strategy has a strategic Score below 50 here, with PRICE Scores being 50 and higher):

¹ The studies cited herein were done uisng PowerView™, PQMR's stategic analysis computer program for financial institutions, which was applied to data submitted by commercial banks to federal regulators as of Jun. 30, 2002. Strategic Score, Focus, and Drift are statistical products of this coputer program (Pat. Pend. 2002).

[image]

The strategic Score in this graphic is a composite, based on differences at the “tactical activity” level in each of the nation's banks. For example, if a bank seeks to serve commercial customers, emphasizes personal sales and negotiated transactions, and pays incentive compensation on the basis of volume and transaction size, it is pursuing a PRICE strategy, and should be concentrating resources on these tactical activities. On the other hand, if the target customer values the bank's services, the product line is broad and standardized, the distribution system relies on extensive and convenient locations and an aggressive advertising program, then VALUE is the strategic emphasis—and value-oriented tactical activities should receive both attention and any discretionary strategic resources.

There are conceptual queries that can be used to place a bank's perceived strategy, in a decision-maker's mind, on the VALUE—PRICE scale. Among them, for example: do you think of your customer relationship as “personal” (value) or “professional” (price)? Is your offering best known as a “brand” (value) or a “product” (price)? Is your risk-taking capacity an opportunity (value) or a constraint (price)? Do you achieve scale economy through automation (value) or transaction size (price)?

These and other strategic beliefs, and the PRICE- or VALUE-oriented decisions that result from them, allow a bank's overall executed strategy to be placed on the Strategic Dimension between VALUE and PRICE. More on this in a minute.

Strategic Focus

All of the myriad decisions made within the organization define its strategy as seen by the marketplace, and this “executed” strategy is the one that positions the bank (or credit union, or thrift) vis-à-vis its competitors as it seeks profitable customer relationships. So every bank has a strategy, whether it has a formal “Strategic Plan” or not, and even if there is
² Pre-tax ROE was used in all studies to measure financial performance. a “planned” strategy, the “executed” strategy (the important one) may not accurately reflect the plan.

There is no evidence that any strategic position is generically better than any other, when financial performance² is used as the criterion. There is, however, strong evidence that the quality of strategic execution (whatever the chosen strategy) does drive financial results. When tactical consistency—the alignment (or “Focus”) of those myriad tactical decisions with the overall “executed” strategy—increases, so does financial performance.

An example will help explain the “Focus” concept. The pursuit of a PRICE strategy by the smallest competitor in a particular market is made difficult by its inability to achieve scale economy based on transaction size. Its relatively high overhead-per-transaction is inconsistent with a PRICE strategy (for which efficiency is key), and so reduces the bank's Focus. The bank can expect lower risk-adjusted returns as a result.

Another example of an inconsistent tactical decision: employing an outside sales force in a bank with a VALUE-based strategy. Here, the acquisition cost of each customer is so high that the relationship (discounting future net income, and assuming a finite average relationship “life38 ) rarely achieves an adequate return to justify the initial investment. The sales tactic chosen is inconsistent with the strategic goal (out of Focus), and performance is adversely affected.

Decisions like these, and in fact all tactical decisions can be observed in every institution's financial statements, where tactics leave, well, “tracks”. Standardizing these tactical tracks and placing them on the Strategic Dimension allows tactical consistency with the bank's strategic goal to be measured. The result—strategic “Focus”—is positively correlated with financial performance², as shown here for banks located in California^{1,3}:

[image]

Regression analysis of the relationship between Focus and P/T ROE indicates that, for example, improving Focus by 20 points has the expected effect of improving P/T ROE by 5%. This positive correlation carries over to the entire population of banks in the nation.

Intuitively, this seems trivial. An uncoordinated tactical effort will probably result in waste and inefficiency, and thus in lower performance. What may not be obvious, however, is that each tactical decision-maker can in fact be maximizing his own individual results, and yet not be supporting the organization's overall strategy. A good (and actual) example is of the portfolio manager of an asset-sensitive New York bank who, convinced that rates would increase soon, shortened portfolio duration in an effort to maximize the bank's total return on its investments (that being the basis, incidentally, for his incentive compensation)—adding to the bank's interest rate risk, reducing its income and its strategic Focus, all while doing his best to do his job.

This is classic sub-optimization error (the mistaken inference that the sum of optimal individual results is the optimal overall result). Sub-optimization error is a common source of low strategic Focus in the financial institutions I have studied.

Strategy's Role, and its Limitations

To repeat, the role of strategy cannot be seen in its relationship to financial performance. In my studies, both nationally and regionally, there is no financial advantage of any strategic goal over any other^{1,2}. Continuing with the data from California^{1,3}:

³ There are an almost infinite number of influences on pre-tax ROE, including the economic environment, competition, risk profile, and seasonal factors. Isolating the impact of a single variable, “Focus” in this case, requires a sufficiently large sample to supress other influences; the California sample of over 300 institutions meets that test.

[image]

The data clearly reflects the national bifurcation of strategic goals, shown previously, into VALUE (lower scores) and PRICE populations. Regression analysis here shows no statistically significant link, however, between strategic Score and pre-tax ROE³. Strategy doesn't drive performance; Focus does. In California, and nationwide.

A well-chosen but poorly executed strategy (low Focus) appears to create a frustrating barrier to success, whereas a well-executed strategy can succeed even under difficult market conditions. Furthermore, this observation appears to be true along the entire spectrum of strategic choices.

So, the first and most important goal of formal strategy is to provide a focal point for daily tactical decisions within the organization—the tactical bulls-eye. To accomplish this goal, the strategy must be clear and must be reduced to its tactical components. These tactical guides in turn must be measurable, and must be communicated (along with the strategy) throughout the organization, rationalizing any departures from the optimization of organizational sub-units. To do his part strategically, every member of the team must understand the place he occupies in the total team effort, and how it relates to the contribution made by other team members.

The second important role played by a formal strategy follows from the first, that is, to encourage consistency in decision-making over time. In its impact in the marketplace, strategy is cumulative: a consistently well-executed strategy helps the market to know and trust the institution, without having to be re-introduced time and again to a new organizational personality. The cumulative effect of strategic repetition creates a kind of efficiency, almost like an investment in the future. The return on this investment comes from occupying a permanent niche in the minds of both current and future customers—an attraction, a strong bond, and a significant barrier to competition. On the other hand, “Strategic Drift”, or a change in strategy brought about by misguided tactical decisions, negates this advantage and is truly an enemy of long-term success in the marketplace.

As a financial institution develops its strategy, then, it has broad flexibility in choosing where it wants to be on the Strategic Dimension of VALUE vs. PRICE. The criteria for choosing a strategy are well-known and accepted: the decision should take into account the natural attributes of the organization, the character of the market, and the competitive environment, as well as the values of the institution itself. Once its strategic position is chosen, the institution's success will depend on (1) the ability to express its chosen strategy in measurable, tactical terms; and (2) the leadership to guide the organizational team in consistent tactical execution over time.

In the business context, the overarching goal of all stakeholders is to assure the institution's successful long-term future. The strategic process—planning, communicating, executing, measuring and reporting, coaching—literally powers the organization's pursuit of this goal. Strategy and its tactical implementation form the backbone of leadership: focused tactical execution, consistent allocation of organizational resources—and a strong future, achieved one day at a time.

With reference to the figures, the following additional description is added:

### COMMENTARIES ON EXAMPLE BANKS

### Example Bank 1

This bank has a value-oriented “Actual Strategy” (<S> of 37), and a “Calculated Focus” of 52, which is above the California average of 35 but which can be improved toward the PowerView target of <F>=65. The detailed tactical analysis indicates that “Liability Cost” is below the strategic support level (values must be inside the dark rectangle to infer strategic support), as is “Risk vs. Capacity” and “Cost vs. Equity”.

The apparent solution is to attract (possibly expensive) liabilities and deploy the proceeds in a mix of loans and investments designed to maintain “Liquidity” and “Portable Market Risk” as supporting tactics. Additional overhead will be required to support the loan volume, which cost must be anticipated. This solution is implemented in FIG. 7 and the result is shown in FIG. 8 of the general PowerView description, of which Example Bank 1 is a part; the “Calculated Focus” reaches 94, and the “Actual Strategy” moves only to 40, and the after-tax ROE increases 90% from the present level.

### Example Bank 2

Here the PowerView report shows a dramatic shift in the bank's “Actual Strategy” (from 65 six months ago to the current 47, as shown by the difference between the “shadow” strategic rectangle and the darker, current strategy limits). The bank's “Calculated Focus” of 61 is well above average and near the PowerView goal of 65. The tactical exceptions are (1) low “Liability Cost” relative to the “Actual Strategy”, (2) low “Portfolio Market Risk”, and (3) low overall “Risk vs. Capacity”.

The best tactical approach is probably to add market risk to the portfolio, which the (supportive) “Liquidity” measure allows, possibly raising market-rate liabilities to do so. Thus bringing “Liability Cost” and “Portfolio Market Risk” into the (darker) area of strategic support would simultaneously add interest margin and boost profitability, because no additional overhead would be required. “Calculated Focus” could be expected to improved dramatically”.

The amount of strategic “drift” in this bank remains a concern. Strategy is by nature a long-term commitment, and to change the “Actual Strategy” by this much in so short a period is unusual. Management should comment to the bank's governing body on the reason(s) for the change.

### Example Bank 3

This is an example of a consistent value-oriented strategy (<S> of 30, very little “drift” during the past six months). The tactical exceptions (low “Risk vs. Capacity” and low “Cost vs. Equity” have in common the level of the bank's equity, and so the first solutions to be investigated are to either (1) reduce equity through distribution; or (2) to acquire scale through targeted acquisition of institution(s)/related businesses. Either will push the “Calculated Focus” well above the PowerView target, and will increase profitability, possibly significantly.

1. A strategic business method for financial institutions, comprising:
establishing a strategic metric;
setting measurable goals using the established strategic metric;
communicating the goals effectively; and
measuring and reporting progress in reaching the goals.

2. A strategic business tool for financial institutions, comprising:
structure for establishing a strategic metric;
structure for setting measurable goals using the established strategic metric;
structure for communicating the goals effectively; and
structure for measuring and reporting progress in reaching the goals.
